(19) United States
(12) Patent Application Publication
(10) Pub. No.: US 2011/0250347 A1
(43) Pub. Date: Oct. 13, 2011

(54) Method and apparatus for forming contact gaps in continuous welding electrode

(76) Inventor: Xue Feng Ni, Richmond Hill (CA)

(21) Appl. No.: 12/662,236

(22) Filed: Apr. 7, 2010

(51) Int. Cl. B05D 5/12; B05C 9/12

(52) U.S. Cl. 427/59; 118/63

(57) ABSTRACT

Circular contact gaps are formed in the welding flux coating of a continuous welding electrode by locating the electrode in a fabrication duct having the same diameter as the flux coating. High pressure air is injected at evenly spaced position of the flux coating through two air injection air ports from 45 degree angles relative to the cross sectional diameter of the fabrication duct. Contact gaps are formed in alternate consecutive sections of the welding electrode in sequential consecutive steps in which a new section of the electrode is located in the fabrication duct in each sequential step.

### BACKGROUND OF THE INVENTION

1. Field of the Invention

This invention relates to the method and apparatus for forming contact gaps in a continuous welding electrode and particularly the forming of evenly spaced contact gaps in a small size continuous welding electrode.

2. Background Art

A continuous welding electrode consists of a continuous metal core having a welding flux coating in which evenly spaced and equal length flux coating sections are separated by evenly spaced contact gaps formed in the coating. The contact gaps expose sections of the metal core in order that the welding electrode may be used with a welding apparatus commonly referred to as a welding gun. The welding gun has a clamping carrier which would engage with the contact gap of the electrode for gripping the welding electrode at the contact gap for moving the electrode towards the welding working piece as well as for delivering the welding current for the welding operation through the metal core in contact with the clamping carrier at the contact gap. A continuous welding electrode facilitates the welding operation to be carried out continuously so as to obtain a high quality weld.

Heretofore, continuous welding electrode is formed by first applying the flux coating on the continuous metal core, and the coated electrode is then passed through an abrasion station at which mechanical means such as wire brushes are employed to remove one side or two opposite sides of evenly spaced portions of the flux coating for forming the required contact gaps. The contact gaps thus formed expose only one side or at most two opposite sides of the metal core of the electrode at each contact gap. Therefore, the welding current can only be applied to the metal core through the single exposed side of the contact gap of the electrode or at most two opposite exposed sides of the contact gap of the electrode. The efficiency of the welding current delivered to the metal core is thus restricted by the limited size of surface contact between the metal core and the clamping carrier of the welding gun. Also, the contact gaps formed by mechanical brushes usually do not have a thoroughly clean contact surface and the residual flux material remained in the contact gap inherently introduces undesirable resistance to the amount of current that can be conducted to the metal core.

Furthermore, rough edges are often formed in the side edges of the flux coating sections between the contact gaps by the abrading wire brushes, and more often portions of edge portions of the flux coating sections may be invariably removed in the abrading operation with the brushes. As the drive of the welding electrode relies largely on the engagement of the clamping carrier of the welding gun with the contact gaps as well as by the abutment with the side edges of the flux coating sections, rough or missing edges of the flux coating sections would greatly affect the accuracy of the engagement between the clamping carrier and the electrode, and any rough or missing edges of the flux coating sections would result in the uneven advance of the welding electrode towards the welding work piece to result in the formation of an uneven weld having poor quality as well as undesirable surface appearance.

Moreover, ever smaller size welding electrodes formed on a small size metal core are required in continuous welding electrodes in order to increase the amount of the electrode that can be adapted in the welding gun on a supply reel and to operate with precision high speed welding guns. Formation of contact gaps in such small size welding electrodes with mechanical wire brushes is not feasible.

### SUMMARY OF THE INVENTION

It is a principal object of the present invention to provide a method and apparatus of forming precise evenly spaced highly clean contact gaps and equal length flux coating sections in a continuous welding electrode.

It is another object of the present invention to provide a method and apparatus of forming evenly spaced contact gaps in a continuous welding electrode in which the contact gaps are circular rings exposing a complete 360 degree surface of the metal core to provide a maximum current contact surface for conducting the maximum amount of welding current to the metal core.

It is another object of the present invention to provide a method and apparatus of forming contact gaps in a continuous welding electrode in which the flux coating sections have accurate edges so as to facilitate the precision drive of the welding electrode towards the welding work piece by the clamping carrier of the welding gun.

It is yet another object of the present invention to provide a method and apparatus of forming very clean contact surface in the metal core surface exposed in the contact gaps in order to ensure maximum welding current can be delivered to the metal core.

### BRIEF DESCRIPTION OF THE DRAWINGS

Other objects of this invention will appear in the following description and appended claims, reference being made to the accompanying drawings forming a part of the specification in which

FIG. 1 is a front perspective elevation view of the contact gaps forming apparatus according to the present invention.

FIG. 2 is a rear perspective elevation view thereof.

FIG. 3 is a top perspective elevation view thereof.

FIG. 4 is a left side perspective elevation view thereof.

FIG. 5 is an isolated top perspective elevation view of the lower section of the apparatus according to the present invention showing the two parallel longitudinal channels having a semi-circular cross sectional shape. A plurality of evenly spaced pressure air inlet ports are formed on the side wall of both channels.

FIG. 6 is an isolated top perspective elevation view of the lower section of the apparatus with two elongated cylindrical control valve rods slidably located in the longitudinal channels. The cylindrical control valve rods have evenly spaced circular channels formed therein.

FIG. 7 is a bottom perspective elevation view of the middle section of the apparatus showing the formation of the two parallel complementary semi-circular channels at the middle portion therein for accommodating the cylindrical control valve rods when the middle and lower sections are mounted together.

FIG. 8 is a top perspective elevation view of the middle section mounted on the lower section of the apparatus showing a semi-circular channel extending throughout the entire longitudinal length of the middle thereof for the coated welding electrode to pass through the apparatus. A plurality of evenly spaced injection air ports are formed in the channel for forming a plurality of contact gaps in the flux coating.

FIG. 9 is an isolated bottom perspective elevation view of the top section of the apparatus showing the a complementary semi-circular channel extending throughout the entire longitudinal length. The semi-circular channel of the middle section and the complementary semi-circular channel of the top section engage with one another to form the circular duct for admitting the coated electrode to pass through the apparatus for the formation of the plurality of contact gaps when the top section is mounted to the middle section of the apparatus.

FIG. 10 is an isolated enlarged cross sectional view along section line X-X of FIG. 3.

FIG. 11 is an isolated enlarged cross sectional view of the pressure air ducts, injection ports, and outlet ducts formed in the top, middle and lower section respectively of the apparatus for forming the contact gap in the coated welding electrode.

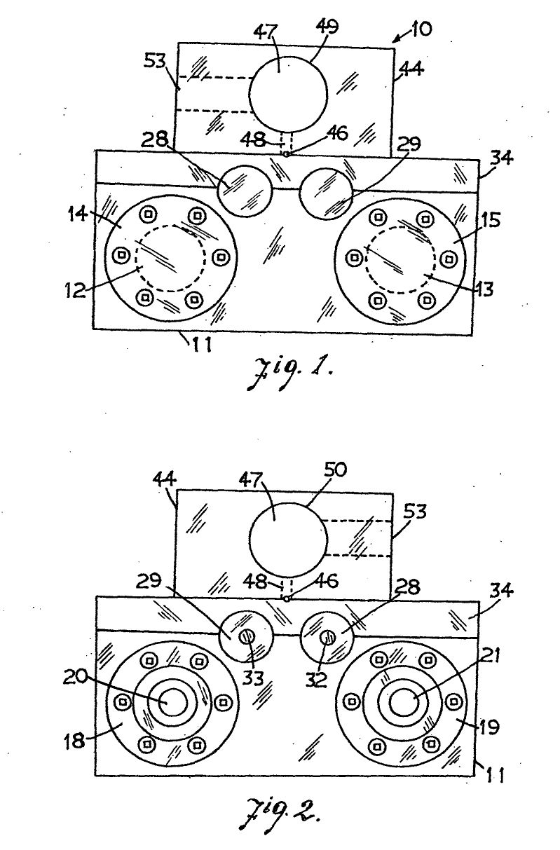

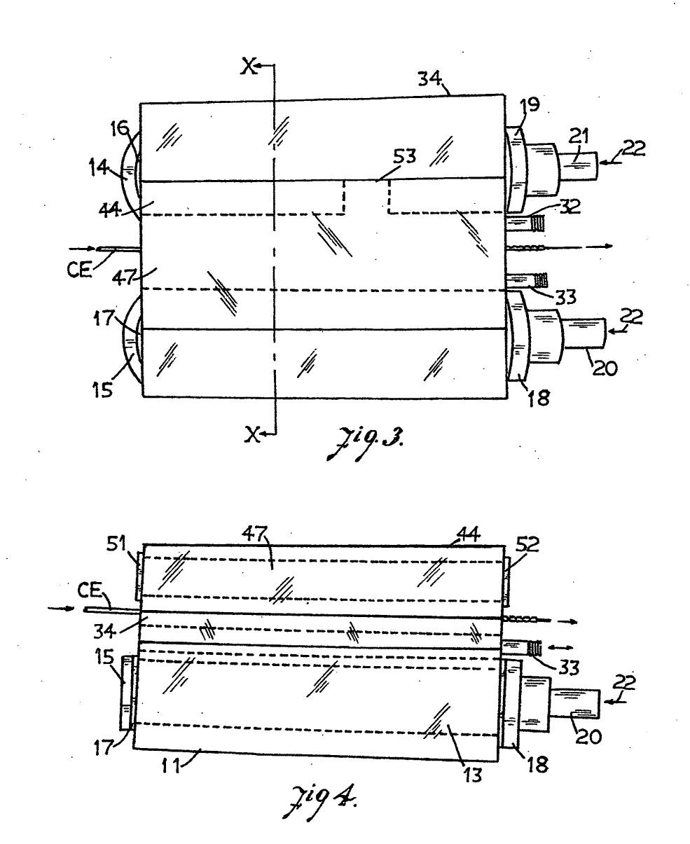

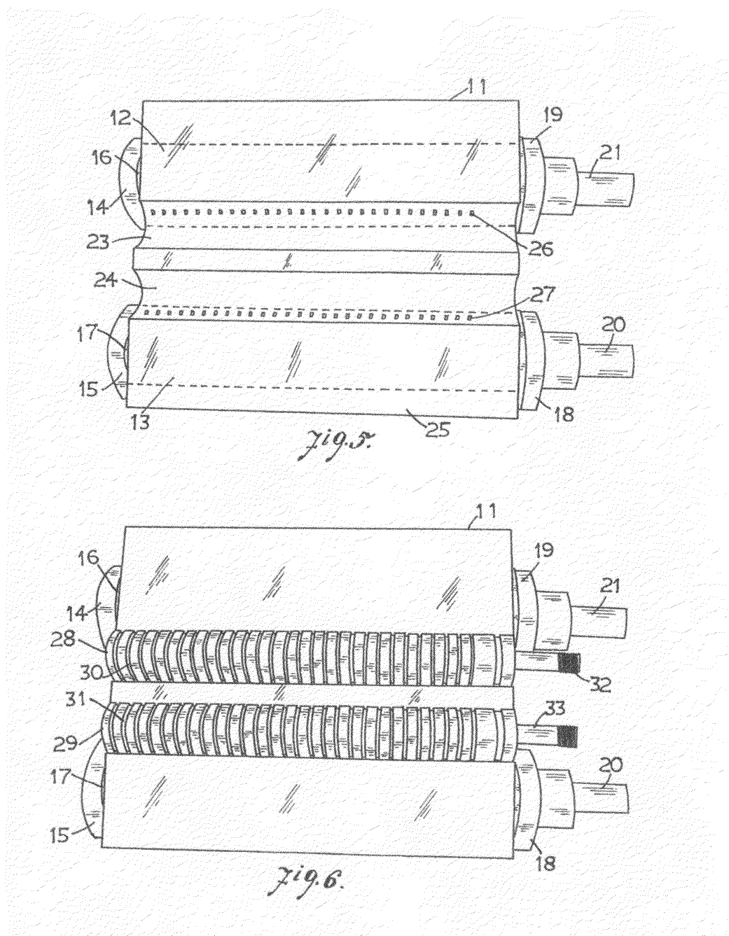

### DETAILED DESCRIPTION OF THE PREFERRED EMBODIMENTS

With reference to the drawings in which same reference numerals designate like items in the several different views, the contact gaps forming apparatus 10 of the present invention includes a rectangular lower section 11 having two parallel elongated cylindrical air chambers 12 and 13 extending throughout its entire longitudinal length. The air chambers 12 and 13 may alternatively have a square or rectangular cross sectional shape. The front end of the air chambers 12 and 13 are covered by front covers 14 and 15 respectively and gaskets 16 and 17 are provided between the air chambers and the front covers to ensure an air tight seal. The rear end of the air chambers 12 and 13 are covered by brackets 18 and 19 having coupling pipes 20 and 21 for connection to a supply source of high pressure compressed air 22.

Two semi-circular parallel channels 23 and 24 are formed on the top surface 25 of the lower section 11. The semi-circular channels 23 and 24 are located at the middle portion of the top surface 25 and extend throughout the entire longitudinal length of the lower section 11. A plurality of evenly spaced air inlet ports 26 are formed along the longitudinal edge portion of the semi-circular channel 23, and similarly a plurality of evenly spaced air inlet ports 27 are formed along the longitudinal edge portion of the semi-circular channel 24.

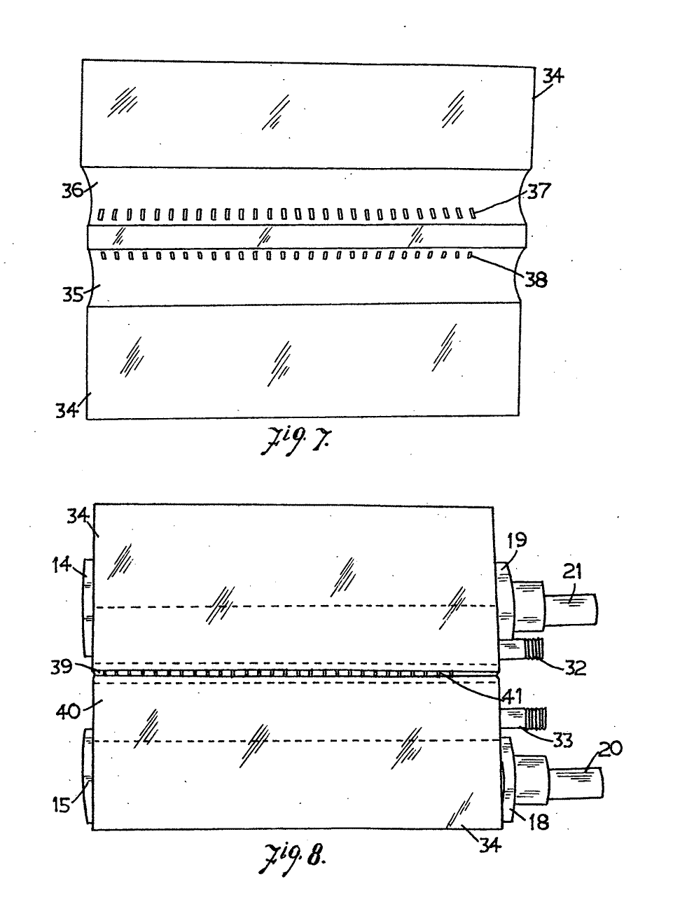

Two elongated cylindrical control valve rods 28 and 29 are slidably located in the semi-circular channels 23 and 24 respectively. The cylindrical control valve rods 28 and 29 have a diameter equal to the diameter of the semi-circular channels 23 and 24. A plurality of circular channels 30 and 31 are formed on the circumferential surface of the cylindrical control valve rods 28 and 29 respectively as best shown in FIG. 6. The width of the circular channels 30 and 31 is equal to the width of the air inlet ports 26 and 27 formed in the semi-circular channels 23 and 24. The cylindrical control valve rods 28 and 29 are slidably movable with respect to the lower section 11 of the apparatus 10 so that pressure air from the air chambers 12 and 13 may flow from the air inlets ports 26 and 27 to the circular channels 30 and 31 of the cylindrical control valve rods 28 and 29 when the air inlets ports 26 and 27 are aligned with the circular channels 30 and 31 of the cylindrical control valve rods 28 and 29, and the air inlets 26 and 27 of the circular channels 30 and 31 are covered when the circular channels 30 and 31 of the cylindrical control valve rods 28 and 29 are offset from the air inlet ports 26 and 27 to prevent the high pressure air in the air chambers 12 and 13 to flow into the circular channels 30 and 31 of the cylindrical control valve rods 28 and 29. Threaded attachment rods 32 and 33 are provided at the rear end of the cylindrical control valve rods 28 and 29 respectively. The attachment rods 32 and 33 are attachable to a mechanical means (not shown) which can be operated under a central control means for slidably moving the cylindrical control valve rods 28 and 29 to align with or to offset from the air inlet ports 26 and 27 selectively.

The rectangular middle section 34 is mountable on the lower section 11. Two elongated parallel complementary semi-circular channels 35 and 36 are formed in the middle portion of the bottom surface of the middle section. The semi-circular channels 35 and 36 extend throughout the entire longitudinal length of the middle section. The semi-circular channels 23 and 24 of the lower section 11 engage with the complementary semi-circular channels 35 and 36 respectively to form the two cylindrical housings for accommodating the cylindrical control valve rods 28 and 29 when the middle section 34 and mounted on the lower section 11. A row of plurality of spaced rectangular air outlet ports 37 and 38 are formed along the inner side wall of the complementary semi-circular channels 35 and 36 as best shown in FIG. 7. The spacing between the rectangular air outlet ports 37 and 38 is equal to the spacing between the circular channels 30 and 31 formed in the circumferential surface of the cylindrical control valve rods 28 and 29. The circular channels 30 and 31 will be aligned with the air outlet ports 37 and 38 when the cylindrical control valve rods 28 and 29 are slidably moved to the position with the circular channels 30 and 31 aligned with the air inlet ports 26 and 27 so that the pressure air from the air chambers 12 and 13 will flow from the air inlet ports 26 and 27 through the circular channels 30 and 31 to the air outlet ports 37 and 38.

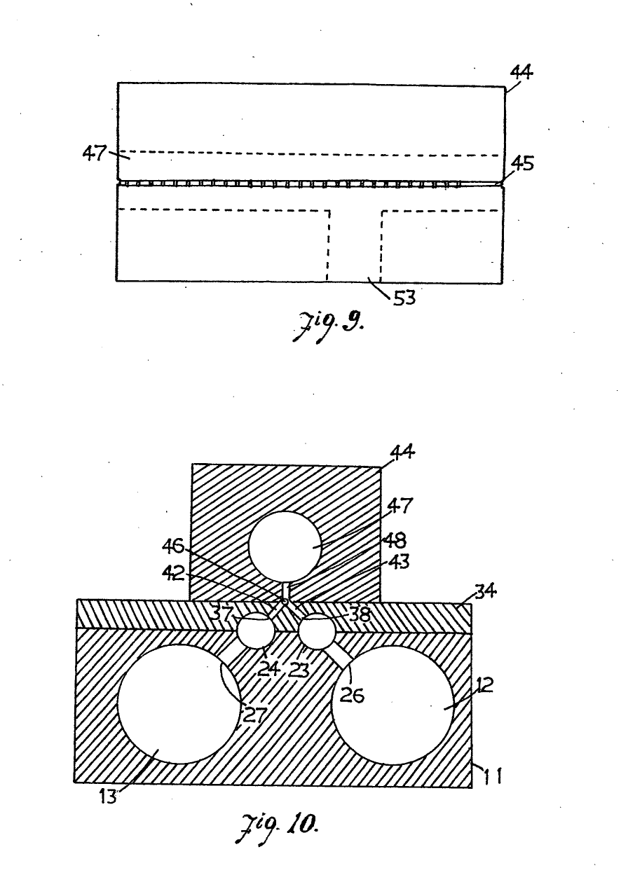

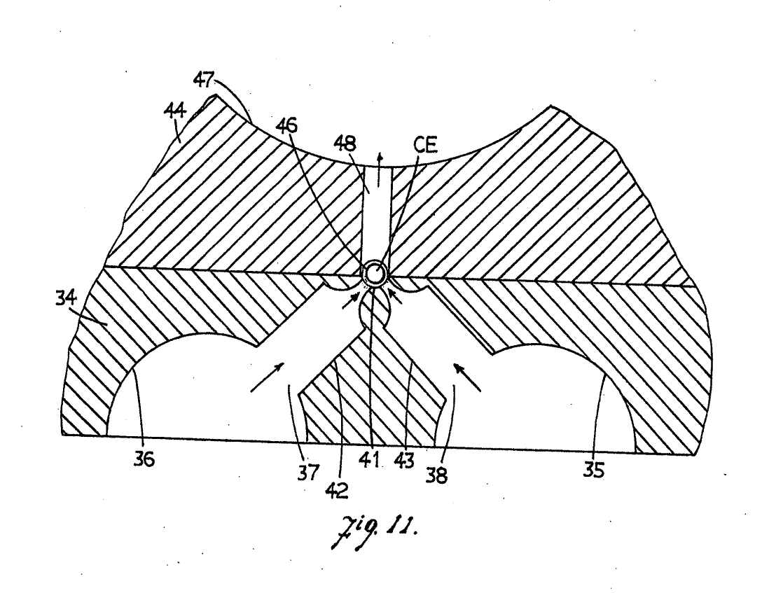

As best shown in FIG. 8, an elongated semi-circular channel 39 is formed at the middle of the longitudinal portion of the upper surface 40 of the middle section 34. The semi-circular channel 39 has a diameter equal to the diameter of the flux coated welding electrode. A plurality of evenly spaced air injection inlet ports 41 are formed in the semi-circular channel 39. The spacing between neighboring air injection inlet ports 41 is equal to the spacing between the neighboring contact gaps of the welding electrode to be formed. The air injection inlet ports 41 are in communication with both the air outlet ports 37 and 38 through air ducts 42 and 43 as best shown in FIG. 10. The air ducts 42 and 43 are preferably extending at 90 degree relative to one another and at a 45 degree angle to the diameter at two lower sides of the semi-circular channel 39, and these air ducts have a reduced diameter inner portion as best shown in FIG. 12 so that the pressure air injecting from two sides of the injection inlet port 41 with an extremely high pressure.

A rectangular upper section 44 is mountable on the middle section 34. An elongated complementary semi-circular channel 45 is formed at the middle of the bottom surface of the upper section 44. The complementary semi-circular channel 45 is equal in dimensions to those of the semi-circular channel 39 such that when the upper section 44 and the middle section 34 are mounted together, the semi-circular channel 39 and the complementary semi-circular channel 45 engage with one another to form the fabrication duct 46 for the coated electrode CE to pass through the apparatus 10 for forming the contact air gaps therein. A collection chamber 47 is formed in the upper section 44. The collection chamber 47 may have a cylindrical cross section shape as shown in the drawing and it extends throughout the entire longitudinal length of the upper section 44. The collection chamber 47 is in communication with the fabrication duct 46 through dispensing ducts 48 formed between the collection chamber 47 and the fabrication duct 46. The front end opening 49 and rear end opening 50 of the collection chamber 47 are closed with covers 51 and 52 respectively. A dispensing opening 53 is formed in the side wall of the collection chamber 47. An outlet tube (not shown) may be coupled to the upper section 44 for conducting the excess flux coating material removed from the electrode CE in the formation of the contact gaps in the fabrication process for recycling to the flux coating process.

In the contact gaps forming process, the cylindrical control valve rods 28 and 29 are controlled by the central main control to position slidably in alternate steps to align the circular channels 30 and 31 with the air inlet ports 26 and 27 and the outlet air ports 37 and 38 while the coated electrode CE is maintained in place in the fabrication duct 46 so that the compressed air from the air chambers 12 and 13 will be injected through two air injection inlet ports 41 at opposite lower 45 degree angles relative to the vertical cross sectional diameter of the fabrication duct 46 at the desired spaced positions so as to remove the flux coating material of the welding electrode at these positions. The high pressure air will cause a 360 degree circular ring of contact gap to form in the flux coating material around the electrode, and the material will be completely removed and ejected through the dispense ducts 48 to the collection chamber 47 in which the removed material may be subsequently collected for recycling to the flux coating process. With such high pressure air injection, the contact gaps formed have a very clean contact surface and the flux coating sections have accurately formed side edges. A plurality of contact gaps are formed by the plurality of inlet ports 41 spaced at a predetermined distances between neighboring flux coating sections. After the contact gaps are formed in the section of the electrode located in the fabrication duct in the apparatus, the cylindrical control valve rods 28 and 29 are moved to the position to shut off the communication between the air inlet ports 26 and 27 and the outlet air ports 37 and 38, and the coated electrode CE is then advanced to the next section in the fabrication duct 46 with the next section located at the air injection ports 41 in the fabrication duct. The cylindrical control valve rods 28 and 29 are again moved to align the air inlet ports 26 and 27 and the outlet air ports 37 and 38 so that air is injected through the air injection ports 41 to form the contact gaps in this new section of the welding electrode. Thus, the movement of the cylindrical control valve rods 28 and 29 and the advance of the electrode through the apparatus are actuated in sequential alternate steps to form the contact gaps accurately in the welding electrode sequentially section by section according to the present invention.

The method and apparatus of the invention is particularly advantageous in forming evenly spaced contact gaps in small size of welding electrodes such as those having a maximum diameter of 2 mm.

While the present invention has been shown and described in the preferred embodiment thereof, it will be apparent that various modifications can be made therein without departing from the spirit or essential attributes thereof, and it is desired therefore that only such limitations be placed thereon as are imposed by the appended claims.

1: An apparatus for forming evenly spaced contact gaps in a continuous welding electrode
comprising,
a generally rectangular body including a rectangular lower section, a rectangular middle section mounted over said lower section, and a rectangular upper section mounted over said middle section,
an elongated open-ended fabrication duct formed between said middle section and said upper section and extending throughout the entire longitudinal length of both said middle section and said upper section, said open-ended fabrication duct being operative for receiving said continuous welding electrode having a coating of a welding flux material to pass through said apparatus for forming at least one contact gap in said coating of welding flux material,
air chambers formed in said lower section and adapted to maintain a high pressure air therein,
a control air valve means located between said lower section and middle section,
input air ducts extending between said air chambers and said control air valve means,
two injection air ducts located in said middle section and having injection air ports located at 90 degrees relative to one another and at 45 degrees relative to a vertical diameter of said fabrication duct and being operative to direct said high pressure air from said air chambers through said control air valve means at said coating of said welding flux material of said welding electrode for forming a circular contact gap in said welding electrode.

2: An apparatus according to claim 1 wherein said fabrication duct having a diameter equal
to the diameter of said coating of said welding flux material of said welding electrode.

3: An apparatus according to claim 2 including a plurality of consecutive evenly spaced
injection air ports formed in said middle section located along the longitudinal length of said fabrication duct and operative to direct said high pressure air at a plurality of consecutive evenly spaced positions of said coating of said welding flux material of said welding electrode for formation of consecutive evenly spaced circular contact gaps in said welding electrode.

4: An apparatus according to claim 3 including a collection chamber formed in said upper section, and a dispensing duct extending from said fabrication duct to said collection chamber, said dispensing duct being operative to convey flux coating material removed from said welding electrode in the formation of said circular contact gaps to said collection chamber.

5: An apparatus according to claim 4 wherein said control air valve means includes two elongated cylindrical channels formed between said lower section and said middle section, two elongated cylindrical rods slidably located in said cylindrical channels, said cylindrical rods having a circular surface with a plurality of evenly spaced consecutive circular air gaps formed therein, neighboring circular air gaps of said cylindrical rods being spaced at a distance equal to the distance between neighboring injection air ducts, said cylindrical rods being selectively movable slidably to align said circular air gaps with said injection air ducts for delivering said high pressure air to said injection air ports for forming said consecutive evenly spaced contact gaps in said welding electrode.

6: An apparatus according to claim 5 wherein said cylindrical rods being selectively movable slidably to off set said circular air gaps with said injection air ducts to terminate said high pressure air from flowing to said fabrication duct to facilitate positioning of a next section of said welding electrode in said fabrication duct for contact gaps forming therein whereby contact gaps are formed sequentially section by section located in said fabrication duct.

7: A method of forming a contact gap in a welding flux coating of a continuous welding electrode comprising,
locating said continuous welding electrode in a fabrication duct having a diameter equal to the diameter of said welding flux coating,
directing high pressure air from two injection air ports located at 90 degrees relative to one another and at a predetermined angle relative to a cross sectional diameter of said fabrication duct for forming a circular contact gap in said continuous welding electrode.

8: A method according to claim 7 including the step of directing pressure air from a plurality of injection air ports located along the entire length of said fabrication duct, said injection air ports being positioned in predetermined consecutive evenly spaced positions along said fabrication duct for forming consecutive evenly spaced contact gaps in said welding electrode.

9: A method according to claim 8 including selectively controlling said pressure air from delivering to said injection air ports with a control air valve means in alternate sequential steps for moving a new section of said welding electrode during said alternative sequential steps when said pressure air is not delivered to said injection air ports whereby evenly spaced contact gaps are formed in said welding electrode in said alternate sequential steps.

10: A method according to claim 9 including the step of conducting flux coating material
removed from the formation of said contact gaps through a dispensing duct to a collection chamber, and recycling said flux coating material from said collection chamber for recycling in a flux coating process.

11: An apparatus for forming evenly spaced contact gaps in a continuous welding electrode comprising,
a generally rectangular body including a rectangular lower section, a rectangular middle section mounted over said lower section, and a rectangular upper section mounted over said middle section,
an elongated open-ended fabrication duct formed between said middle section and said upper section and extending throughout the entire longitudinal length of both said middle section and said upper section, said open-ended fabrication duct being operative for receiving said continuous welding electrode to pass therethrough, said welding electrode having an outer coating of a welding flux material,
air chambers formed in said lower section and adapted to maintain a high pressure air therein,
a control air valve means located between said lower section and middle section,
input air ducts extending between said air chambers and said control air valve means,
two injection air ducts located in said middle section and having injection air ports located at 90 degrees relative to one another and at an angle relative to a vertical diameter of said fabrication duct and being operative to direct said high pressure air from said air chambers through said control air valve means at said coating of said welding flux material of said welding electrode for forming a surrounding circular contact gap in said welding electrode.

12: An apparatus as claimed in claim 11 including a plurality of pairs of input air ducts formed evenly spaced in said middle section, each pair of said input air ducts being located at 90 degrees relative to one another and at a predetermined angle relative to the vertical diameter of said fabrication duct and being operative to direct said high pressure air form said air chambers through said control air valve means towards said coating of welding flux material of said welding electrode for forming a plurality of evenly spaced annular contact gaps in said welding electrode.
